(19) United States
(12) Patent Application Publication
(10) Pub. No.: US 2022/0383312 A1
(43) Pub. Date: Dec. 1, 2022

(54) Multiple Format Crypto Currency System and Method

(71) Applicant: Scott C. Harris, San Diego, CA (US)

(72) Inventor: Scott C. Harris, San Diego, CA (US)

(21) Appl. No.: 17/647,684

(22) Filed: Feb. 21, 2022

Related U.S. Application Data
(60) Provisional application No. 63/199,881, filed on Jan. 29, 2021.

(51) Int. Cl. G06Q 20/40; G06Q 20/36

(52) U.S. Cl. CPC G06Q 20/401; G06Q 20/3674; G06Q 2220/00

(57) ABSTRACT

A cryptocurrency system that allows multiple different forms of coins to be handled by a single system, and using a single distributed ledger, where each operation iterates through the mathematical operations for each of the different forms of coins.

This application claims priority from Provisional application No. 63/199,881, filed Jan. 29, 2021, the entire contents of which are herewith incorporated by reference.

### BACKGROUND

Conventional crypto current systems operate by finding a plurality of very large numbers, e.g., a mathematical set, which have some uniqueness to them. Each of the numbers in the crypto current system needs to have specified parameters that make them relatively rare; and the relative scarcity of these numbers sets their value. The numbers In systems like Bitcoin, there are only a specified number of allowable values, often called “coins”. Because bitcoin has become ubiquitous, the very existence of bitcoin numbers specifies their value.

Crypto currency systems are formed based on the premise that there is been an artificial set of terms that are specified by some person or organization. That artificial set of terms defines which numbers are a coin, and hence have a value. By finding those numbers, users in essence “mine” a valuable commodity, that valuable commodity being the numbers that form the coins.

The reality, however, is that a number is a number. Those numbers always existed. Finding numbers which match to a specified characteristic is difficult, but it is not, by itself, necessarily an operation that creates value.

In fact, it has been shown that there are an infinite number of prime numbers; which means that we will never run out of prime numbers. By analogy, the inventor believes that there are an infinite number of sets of numbers that have characteristics that will allow them to be used as alternate style coins.

Bitcoin specifies some characteristic of certain numbers, and specifies that there cannot be more than a certain number of bitcoins (around 21 million). Because of this, there are only a specified number of those bitcoins. Once someone decides that the artificial parameters of bitcoin means that these numbers have a value, it also follows means that there are only a limited number of these coins, and the value will increase as the demand for them increases.

In reality, however, this is nothing but an artificial system. The coins are just numbers. The fact that other people want those coins means nothing, they are simply just numbers.

### SUMMARY

The inventor believes that the reason that these are so valuable is that they were the first crypto currency system. There is a significant demand for crypto currency, because of the realities of e-commerce. However, that demand does not really require or favor any specific form of crypto currency. This is because any specific form of cryptocurrency is merely artificial. The numbers themselves have no value whatsoever other than the fact that the artificial system turns them into coins.

The present system describes a completely new paradigm, where multiple different formats of coin are included in a single system, so that the number of allowable coins is in essence infinite, and their value can be set, rather than fluctuating based on demand.

This system defines a system of buying cryptographic currency and selling cryptographic currency and storing cryptographic currency. However, the cryptographic currency is completely different than the current paradigm of bitcoin and other standard crypto currencies.

According to the present application, multiple cryptographic systems of currency are selected. Each cryptographic system has a specified number format, where there are a plurality of numbers, each of which represent a cryptographic currency or coin, and each of which are difficult or impossible to cryptographically break and cannot be used without a user's private information. In this way, the cryptographic system is much like existing crypto currencies. However, there are may be more than one system of cryptographic algorithms used herein, any of which can be deemed part of the same cryptographic currency.

When the user desires to purchase the cryptographic currency, it is initially purchased from a repository, by tying that cryptographic currency to actual currency valuation. For example, one cryptographic token may be tied to $10,000 US of cryptographic currency valuations. In this way, the cryptographic coin (henceforth simply “coin”) has been exchanged for a real thing of value, e.g., currency or a credit type system which represents a promise to pay or other item of value, henceforth “cash”. The cash is stored by the repository and users can purchase the coins by exchanging cash for the coins. Users can sell the coins to the repository and receive their cash. Users can also sell the coins to one another, understanding that any coins are tied against “cash”, i.e., real and tangible things of value. However, there is no limit to the number of cryptographic systems which can become authorized coins. Each time a new cryptographic currency becomes authorized, that becomes part of the cryptographic currency system.

When testing the cryptographic currency to determine its authorization, the system carries out a serial encryption or decryption operation, using cryptographic algorithm 1 first, cryptographic algorithm 2 second, and cryptographic algorithm 3 third, and so on. There is no limit to the number of cryptographic algorithms that can be used, and hence no limit on the number of coins.

When all or a sufficient number of coins using a first cryptographic algorithm have been found, the system can switch to a second cryptographic algorithm and add that as an authorized encryption and decryption mechanism.

In addition, a distributed ledger of all transactions can still be maintained, but a part of that ledger of transactions includes the operation of the user initially purchasing any coin or percentage of a coin from a repository, by exchanging that coin for money, and then the history of that coin as it proceeds from user to user, or as it is sold back to the repository. The cryptographic ledger can be stored by a plurality of different people. However, any one coin owner may store only a portion of the cryptographic ledger, that portion being the portion which includes the history for the specific coin that the user owns either a piece of, or a complete part of.

### BRIEF DESCRIPTION OF THE DRAWINGS

These and other aspects will now be described with reference to the accompanying drawings wherein:

FIG. 1 shows a block diagram of the system;

FIG. 2 shows a flowchart of buying coins;

FIG. 3 shows a flowchart of verifying coins;

FIG. 4 shows a flowchart of issuing coins; and

FIG. 5 shows a flowchart of spending coins.

### DETAILED DESCRIPTION

The present invention describes a completely new kind of crypto currency system, which uses cryptographic “tokens” or “coins” to represent amounts of money, but uses them in a way that provides an infinite supply of the coins, to maintain the value of the coins at a specified level amount, since there are an infinite number of coins.

The system maintains the infinite supply of coins by allowing multiple different formats of coins to be used.

Each time a new coin format is added to the format of the system, that new system of coin identification is added as an alternative decryption or encryption system as part of the different crypto currency operations.

The different crypto currency operations can include, for example, wallets which store the crypto currency, shopping carts which accept the crypto currency, repositories which issue the crypto currency in return for cash, and distributed ledger systems.

An embodiment describes a computer based client and computer based server for selling, purchasing, storing, transferring, using, and otherwise interacting with, computer based coins that represent currency, henceforth referred to as coins, with the understanding, for the purpose of this patent application, that the coins are in essence just large numbers that meet a specified cryptographic criterion.

An embodiment describes a cryptographic currency, where the currency has value beyond its inherent value as a number, because it was purchased from a repository. A distributed ledger, which is stored by multiple different parties, stores the history of each coin since the moment it was purchased.

A key to making the coin have a constant value, is making sure that there are always enough coins or coins to meet demand. Many of the current coin systems, such as bitcoin, have gone up greatly in price because there were not enough coins to meet demands. This technique described in this specification, ensures that cryptographic coins can have a fixed value relative to some financial system.

In theory anyway, there are an infinite number of cryptographic systems that can be used to create coins. A key to this system is that different cryptographic systems are approved for use each time a first cryptographic system reaches the end, or practical end, of its ability to produce new coins.

In an embodiment, the coins are purchased from a repository. That repository can be a bank, either a private bank or country own bank, or can be another website. For example, websites such as Facebook, Twitter and others can support their own coinage systems, so long as the coins are initially purchased, and are backed by some kind of value that is held by the repository. That value does not change no matter how many coins are sold.

An embodiment is shown with reference to the figures. It should be understood that many of these systems can use the cryptological, mathematical, distributed ledger, and security framework from existing coin trading systems such as bitcoin, ethereum, and from any others.

This includes encrypting and decrypting using the user's private key, hashing, and carrying out any of the other mathematical features necessary to buy, sell and trade coins between parties using a distributed ledger.

The figures show the overall basis and rationale behind this coin system, it should be understood that a person having ordinary skill in the art of cryptographic coin systems would understand how to make the basic mathematics that make this work.

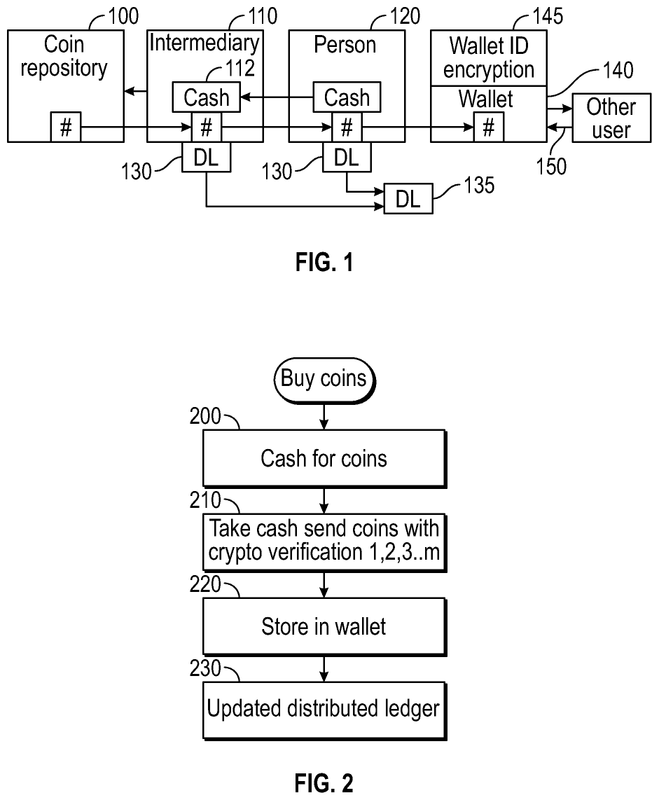

The basic operation of forming the system and communicating information between the parties is shown in FIG. 1. A central repository 100 is the basic institution that holds and releases the coins. This can be the U.S. Federal Reserve Bank, can be a regular bank, or can be any large institution such as a website like a social network such as Facebook, an e-commerce site, or the like. The central repository creates the coins 102 which are sent to an intermediary 110.

The intermediary sells the coins 102 in return for cash or other payment 112 that is received by a coin recipient 120. The coin recipient or “person” exchanges “cash” 112 for the coins 102. As part of the exchange of cash for coins, the details on the transaction, along with cryptographic hashes and cryptographic encryptions are stored in a distributed ledger 130. The distributed ledger may be stored by the person, and may be stored by the intermediary and may be stored by hundreds or thousands or millions of other clients who are connected to the Internet. The many different clients storing the distributed ledger is shown generically as 135, all of whom store the distributed ledger or enough of the distributed ledger to prevent hacking of the distributed ledger.

Once the coins are received, they are stored in a user's cryptographic wallet 140, which has a wallet ID 145 and also includes encryption keys including private keys and identifying information. The wallet may also require 2 factor or multi-factor authentication prior to use of the wallet.

The user can spend the coins 102 that are in the user's wallet as described herein. The user can exchange coins from their wallet with other users, and can receive coins into their wallet from other users. The arrows 150 refer generally to the user using the cryptographic system from their wallet to exchange coins with other users.

The main flow of FIG. 1 represents the user purchasing the coins from the central repository through an intermediary. However, the user can also purchase the coins directly from the central repository without such an intermediary.

FIG. 2 shows a flowchart of operation. At 200, user has cash and wants to buy coins. The user pays the cash to either the intermediary or the central repository, and receives the coins at 210 along with cryptographic verification. These coins, and at least some cryptographic information, are stored in the user's wallet at 220. The distributed ledger is updated at 232 to indicate that the transaction is complete.

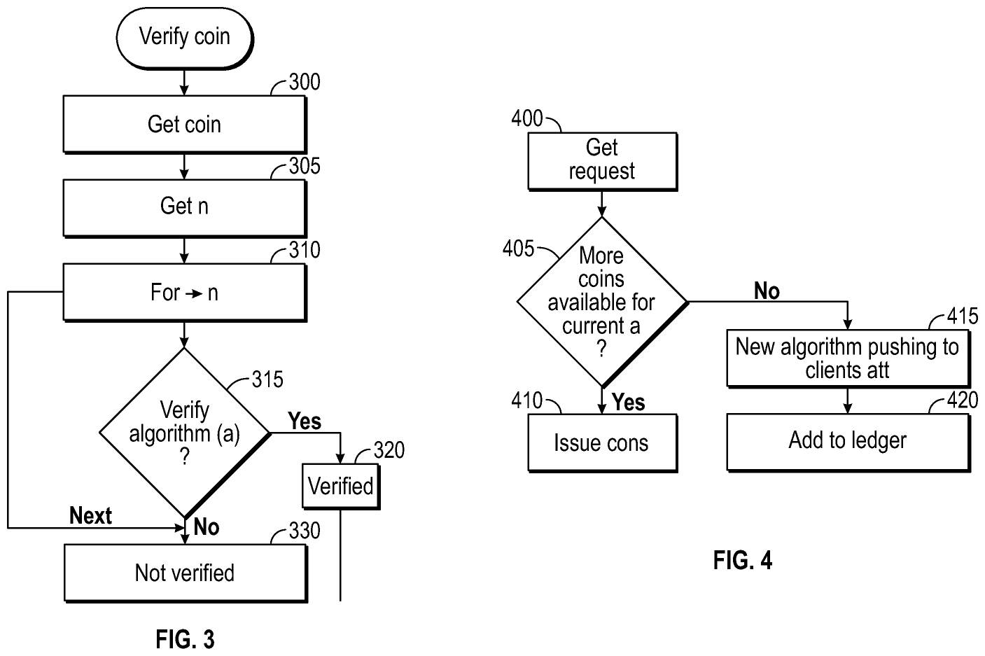

At multiple times during any transactions, one or more client computers may verify cryptographically that the user is authorized to carry out the information that they are carrying out. This ‘verify coin’ process is illustrated in FIG. 3.

At 300, this computer, which may be any computer in the line of inter-connected network computers, gets the coin information. At 305, the computer gets the value n, which may be prestored in the computer, may be part of the distributed network, or may be communicated to the computer in any of a number of different ways. The value n represents information on the different cryptographic algorithms which are used for the coin system. There may be multiple different cryptographic algorithms used for the coin system, and in fact this is necessary to make this coin system work properly.

Each algorithm has a maximum number of coins it can support. Most cryptographic algorithms in reality do could go on forever supporting finding multiple values that uniquely represent the criterion in the cryptographic algorithm. However, as the numbers get larger, it becomes increasingly more difficult to find numbers that support the criterion. For this reason, many coin systems, including bitcoin, set a maximum number of coins which can be included within the system. This is to avoid the excess amount of computing power that would be necessary to support finding the coins.

Unlike systems such as bitcoin that allowed miners to find the coins, in the present system, the central repository must have all the coins it's going to use in advance for a specific algorithmic system. While there are computer costs involved in this, those computer costs could typically be spread in with the transaction costs that are charged to people for using the coin system.

In this system, the value n represents the different number of algorithms which can be verified to use the coin. At 310, the system forms a loop from one to n. For each of 1 to n, the coin is verified using algorithm aₙ. Algorithm aₙ represents the mathematical algorithm used to verify/create/encrypt coins for the value n. Each algorithm aₙ is different than each other algorithm.

For each value a, the system attempts to verify using that algorithm. If the coin is verified using the algorithm a (a1, a2, a3, etc. up to n), then the coin is established is verified at 320, and the system ends. If not, the next algorithm a is used to attempt to verify the coin, until the end of the value a's are received.

It should be understood that each value of n represents a different algorithm aₙ and represent hence represents a different verification mathematical operation being carried out at step 315.

If none of the value a s verify, then the coin is not verified at 330, and the transaction may be refused or not added to the distributed ledger or handled in some other way.

FIG. 4 illustrates the process of adding new coins, as necessary. The system may come out with a first set of coins, and may add new coin systems to its initial set. At 400, the repository gets a request for more coins. 405 indicates the repository determining whether more coins are available for the current coin formation type, referred to as the variable a. If so, the coins are issued at 410. If not, then a new algorithm needs to be published. The new algorithm is published to clients, either in advance of, or in response to the new coins being published. In addition, the variable n is incremented. All of this is done at 415. The information is then added to the distributed ledger at 420. In this way, multiple different cryptographic systems for determining coins are added.

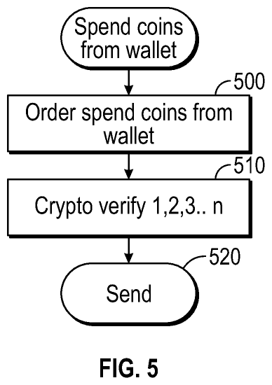

FIG. 5 illustrates the operation of spending coins from a wallet. At 500, the user indicates that they want to spend some of their coins. The coins can be spent back to the repository or to the intermediary, or to a different wallet.

At 510, a crypto verification is carried out. This crypto verification requires that each of the coins be verified using the algorithms a₁ through aₙ. Any time any of the coins are verified as being valid with any of the algorithms, they are taken as valid coins and sent out to the other recipient at 520.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A cryptocurrency system that allows multiple different coin forms to be handled by a single system, and uses a single distributed ledger for each of the multiple different coin forms,
where the distributed ledger is stored by multiple different parties and stores a history of multiple different coins of each of the different coin forms,
and where each form of coin is established as being valid or invalid based on a cryptographic algorithm, and where a first cryptographic algorithm for a first of the forms of coins is different than a second cryptographic algorithm for a second of the form of coins,
and where an operation on the cryptocurrency system checks one or more coins for validity according to both the first cryptographic algorithm and the second cryptographic algorithm.

2. The system as in claim 1, wherein there are multiple additional cryptographic algorithms.

3. The system as in claim 2, where said operation iterates through the multiple cryptographic algorithms at least until finding a cryptographic algorithm that properly validates a coin.

4. The system as in claim 2, wherein there are n different forms of coins.

5. The system as in claim 4, wherein the system assigns a maximum number of coins from each coin form, and after assigning the maximum number of coins from the coin form, chooses a different coin form for additional coins after the maximum number and iterating n to a new value of n+1.

6. The system as in claim 3, the system forms a loop from one to n, and checks each coin using algorithm aₙ, which represents a mathematical algorithm used to verify/create/encrypt coins for the coin form n.

7. The system as in claim 1, wherein the cryptographic system assigns and maintains a fixed value for each coin.

8. A method of assigning, verifying and using cryptocurrency, comprising:
Assigning multiple different coin forms to be handled by a single system, each coin form having a different cryptographic algorithm;
using a single distributed ledger for each of the multiple different coin forms, for storing a history of the multiple different coins of each of the different coin forms;
storing the distributed ledger by multiple different parties;
establishing each form of coin as being valid or invalid based on a cryptographic algorithm, and where a first cryptographic algorithm for a first of the forms of coins is different than a second cryptographic algorithm for a second of the form of coins, and
checking one or more coins for validity according to both the first cryptographic algorithm and the second cryptographic algorithm.

9. The method as in claim 8, wherein there are multiple additional cryptographic algorithms.

10. The method as in claim 9, where said operation iterates through the multiple cryptographic algorithms at least until finding a cryptographic algorithm that properly validates a coin.

11. The method as in claim 9, wherein there are n different forms of coins.

12. The method as in claim 11, further comprising assigning a maximum number of coins from each coin form, and after assigning the maximum number of coins from the coin form, selecting a different coin form for additional coins after the maximum number and iterating n to a new value of n+1.

13. The method as in claim 10, further comprising forming a loop from one to n, and checking each coin using using algorithm aₙ, which represents a mathematical algorithm used to verify/create/encrypt coins for the coin form n.

14. The method as in claim 8, wherein the cryptographic system assigns and maintains a fixed value for each coin.

15. A method of assigning and verifying cryptocurrency, comprising:
assigning a fixed value to coins of cryptocurrency;
using multiple coins of crypto currency until reaching a maximum number of coins for a specific cryptographic algorithm of the crypto currency; and
after reaching the maximum number of coins, selecting a new cryptographic algorithm for the crypto currency and distributing subsequent coins of the crypto currency using the new cryptographic algorithm, while maintaining the fixed value of the coins.
